(19) United States
(12) Patent Application Publication
(10) Pub. No.: US 2004/0143433 A1
(43) Pub. Date: Jul. 22, 2004

(54) Speech communication apparatus

(76) Inventors: Toru Marumoto, Iwaki-city (JP); Nozomu Saito, Iwaki-city (JP)

Correspondence Address: BRINKS HOFER GILSON & LIONE, P.O. BOX 10395, CHICAGO, IL, 60610, US

(21) Appl. No.: 10/725,294

(22) Filed: Dec. 1, 2003

(30) Foreign Application Priority Data
Dec. 5, 2002 (JP) 2002-354164

(51) Int. Cl. G10L 19/14

(52) U.S. Cl. 704/225

(57) ABSTRACT

A transmission-speech extraction filter extracts speech to be transmitted from the output signal of a transmission-speech microphone by using the proximity effect. A background-sound extraction filter extracts background sound from the output signal of the transmission-speech microphone. A background sound level calculation section calculates the level of the extracted background sound in each frequency band, and sends the level to a loudness-compensation control section as a background-sound level. The loudness-compensation control section controls the amount of gain adjustment for a received-speech signal in each frequency band in a gain adjustment section according to the background-sound level and the received-speech level of a received-speech signal, calculated in a received-speech-level calculation section.

### BACKGROUND OF THE INVENTION

1. Field of the Invention

The present invention relates to a technology for improving the clearness of received speech in speech communication apparatuses for performing speech communications, such as telephones.

2. Description of the Related Art

As a technology for improving the clearness of received speech in speech communication apparatuses, a technology has been known as disclosed in Japanese Unexamined Patent Application Publication No. 2000-306181 and No. 2000-69127, for example, in which a background-sound-measurement microphone for collecting background sound is provided for a portable, mobile telephone separately from a transmission-speech microphone, and the frequency characteristic of received speech outputted from a speaker is manipulated according to background sound estimated from sound collected by the background-sound-measurement microphone.

More specifically, as disclosed in Japanese Unexamined Patent Application Publication No. 2000-306181, sound obtained by subtracting speech collected by a transmission-speech microphone from sound collected by a background-sound-measurement microphone is regarded as background sound, and a gain for received speech in each frequency band is manipulated such that the level of the received speech is high at a frequency band where the level of the background sound is low, and the level of the received speech is higher than that of the background sound at an intermediate band of the received speech. As disclosed in Japanese Unexamined Patent Application Publication No. 2000-69127, sound collected by a background-sound-measurement microphone is regarded as background sound, and a gain for received speech is made high at a frequency band where the level of the background sound is low.

According to the above-described conventional technologies, it is necessary to provide the background-sound measurement microphone in addition to the microphone for collecting speech to be transmitted. This prevents mobile telephones from being made more compact and lightweight, and less expensive.

The conventional technologies have an insufficient countermeasure for the mixture of speech to be transmitted (transmission speech) into background sound measured through a background-sound-measurement microphone. As disclosed in Japanese Unexamined Patent Application Publication No. 2000-69127, because sound collected by the background-sound-measurement microphone is directly regarded as background sound, the actual background sound cannot be used. As disclosed in Japanese Unexamined Patent Application Publication No. 2000-306181, sound obtained by subtracting speech collected by the transmission-speech microphone from sound collected by the background-sound-measurement microphone is regarded as background sound. Because the transmission-speech microphone and the background-sound-measurement microphone have different transfer spaces for transmission speech, various characteristics of transmission speech collected by the microphones are different. Therefore, the actual background sound cannot be measured just by subtracting the speech collected by the transmission-speech microphone from the sound collected by the background-sound-measurement microphone.

In the technology disclosed in Japanese Unexamined Patent Application Publication No. 2000-69127 and No. 2000-306181, a gain for received speech is made high at a frequency band where the level of background sound is low to clarify the received speech. Because received speech is not clarified at a frequency band where the level of background sound is not low, when a frequency band where the background-sound level is high overlaps with the main frequency band of the received speech, the received speech cannot be clarified. As disclosed in Japanese Unexamined Patent Application Publication No. 2000-306181, the level of the received speech is made higher than that of the background sound at an intermediate band of the received speech. In an environment where the background sound has a high level at the intermediate band, the level of the received speech may become excessive, which makes it difficult to hear the received speech. With these conventional technologies, because the frequency characteristic of received speech is manipulated, the sound quality of the received speech reaching the person who sends speech may be made unnatural. The quality of the received speech may largely deteriorate.

### SUMMARY OF THE INVENTION

Accordingly, it is an object of the present invention to provide a speech communication apparatus capable of outputting received speech so as to be clearly heard even in an environment where there is background sound, with a single microphone being used.

Another object of the present invention is to provide a speech communication apparatus allowing background sound to be measured more correctly and capable of better clarifying received speech based on measured background sound.

Still another object of the present invention is to provide a speech communication apparatus capable of clarifying received speech reaching the person who transmits speech, without largely reducing the sound quality of the received speech.

The foregoing objects are achieved in one embodiment of the present invention through the provision of a speech communication apparatus for bi-directional speech communications, including a speaker for outputting received speech, a unidirectional or bi-directional microphone for collecting speech to be transmitted, background sound level measurement means for extracting background sound from the output of the microphone and for measuring the level of the extracted background sound, and received-speech clarifying means for adjusting a gain for the received speech to be output to the speaker according to the level of the background sound measured by the background sound level measurement means.

According to such a speech communication apparatus, a background-sound level can be calculated by using only a single microphone without providing a background-sound microphone, to clarify received speech according to the calculated background-sound level.

The foregoing objects are achieved in another embodiment of the present invention through the provision of a speech communication apparatus for bi-directional speech communications, including a speaker for outputting received speech, a unidirectional or bi-directional microphone for collecting speech to be transmitted, background sound level measurement means for manipulating the frequency characteristic of the output of the microphone so as to cancel the proximity effect produced in the output of the microphone to extract speech to be transmitted from the output of the microphone, and for measuring the level of background sound according to the extracted speech to be transmitted, and received-speech clarifying means for adjusting a gain for the received speech outputted to the speaker according to the level of the background sound measured by the background sound level measurement means.

According to such a speech communication apparatus, the frequency characteristic of the output of a microphone for collecting speech to be transmitted can be manipulated so as to cancel the proximity effect produced in the output of the microphone to make the frequency characteristic of speech to be transmitted included in the output of the microphone flat, and the level of background sound included in the output of the microphone can be reduced to successfully extract the speech to be transmitted, from the output of the microphone. Therefore, the level of the background sound can be more correctly calculated from the output of the microphone or a speech signal which includes both speech to be transmitted collected separately and background sound, by using the extracted speech to be transmitted. Consequently, received speech can be effectively clarified according to the background-sound level.

The speech communication apparatus may be configured such that it further includes a background-sound microphone for collecting background sound; the background sound level measurement means includes a transmission-speech filter for reducing the level of a lower-frequency component of the output of the microphone in the frequency band of speech transmitted in the speech communications, an adaptive filter for estimating speech to be transmitted mixed into the output of the background-sound microphone, subtracting means for subtracting the speech to be transmitted estimated in the adaptive filter from the output of the background-sound microphone, and background sound level calculation means for calculating the level of the output of the subtracting means and for outputting the level as the level of the background sound; and the adaptive filter estimates the speech to be transmitted, according to the difference between the output of the background-sound microphone and the speech to be transmitted estimated in the adaptive filter.

According to such a structure, a non-directional background-sound microphone can be disposed at an appropriate position to obtain background sound similar to background sound which the user hears by the background-sound microphone and to correctly estimate speech to be transmitted included in the output of the background-sound microphone according to speech to be transmitted extracted correctly from the output of the microphone by using the proximity effect as described before, and the estimated transmission speech can be removed from the output of the background microphone. Therefore, the level of background sound which the user hears can be more correctly calculated, and received speech can be effectively clarified according to the level of the background sound.

When the transmission-speech filter is provided, the output of the transmission-speech filter may be transmitted as a transmission-speech signal in the speech communications.

The quality of the transmission speech is improved because the frequency characteristic of speech to be transmitted (transmission speech) included in a transmission signal is flattened and the level of background sound included in the transmission signal is suppressed.

The foregoing objects are achieved in still another embodiment of the present invention through the provision of a speech communication apparatus for bi-directional speech communications, provided with a handset having at a front face a speaker for outputting received speech and a transmission-speech microphone for collecting speech to be transmitted, the speech communication apparatus including a unidirectional background-sound microphone disposed at the rear face of the handset at almost the same height as the speaker, for collecting background sound, background sound level measurement means for measuring the level of the output of the background-sound microphone as a background-sound level, and received-speech clarifying means for adjusting a gain for received speech output to the speaker according to the background-sound level measured by the background sound level measurement means.

When a background-sound microphone is disposed at the rear face of the handset at almost the same height as the speaker, in this way, the mixture of speech to be transmitted, into the output of the background-sound microphone is eliminated, the level of the background sound is calculated more correctly, and received signal is effectively clarified according to the level of the background sound.

The foregoing objects are achieved in yet another embodiment of the present invention through the provision of a speech communication apparatus for bi-directional speech communications, including a speaker for outputting received speech, a microphone for collecting speech to be transmitted, background sound level measurement means for measuring the level of background sound, and received-speech clarifying means for adjusting a gain for the received speech to be output to the speaker according to the level of the background sound measured by the background sound level measurement means, wherein the background sound level measurement means includes a first background-sound microphone, a second background-sound microphone, delay means for delaying the output of the first background-sound microphone by the period corresponding to the delay time between transmission speech mixed into the output of the first background-sound microphone and transmission speech mixed into the output of the second background-sound microphone, an adaptive filter for estimating transmission speech mixed into the output of the delay means, subtracting means for subtracting the transmission speech estimated by the adaptive filter from the output of the delay means, and background sound level calculation means for calculating the level of the output of the subtracting means and for outputting the result as the level of the background sound, and the adaptive filter estimates the speech to be transmitted, according to the difference between the output of the delay means and the transmission speech estimated by the adaptive filter.

According to such a structure, when the delay period of the delay means is appropriately specified, directivity in which only sound produced in the mouth direction of the user is masked is given to the output of the non-directional first background-sound microphone. Because the user's auditory sense is close to non-directional, the level of background sound the user hears can be more correctly calculated to clarify the received speech effectively according to the level.

In each of the above-described speech communication apparatuses, it is preferred that the speech communication apparatus include received-speech-level measurement means for measuring, at each predetermined frequency band, the level of a received-speech signal received in the speech communications, the background sound level measurement means measure the level of the background sound in each predetermined frequency band, and the received-speech clarifying means perform loudness compensation in which the gain for the received-speech signal is adjusted in each predetermined frequency band such that the received speech is heard at almost the same intensity in the human auditory sense irrespective of the level of the background sound, and the resultant signal is output to the speaker as the received speech.

With this, the received speech can also be clarified at frequency bands where background sound has high levels while the sound quality of the received speech recognized by the user is not changed.

Each of the above-described speech communication apparatuses may be a portable, mobile telephone for performing the speech communications by radio communication.

The foregoing objects are achieved in still yet another embodiment of the present invention through the provision of a speech communication method for bi-directional speech communications, including the steps of manipulating the frequency characteristic of the output of a microphone for collecting speech to be transmitted so as to cancel the proximity effect produced in the output of the microphone to extract speech to be transmitted from the output of the microphone, measuring the level of background sound according to the extracted speech to be transmitted, and adjusting a gain for received speech to be output to the speaker according to the measured level of the background sound.

As described above, according to the preferred embodiments of the present invention, a speech communication apparatus capable of outputting received speech so as to be clearly heard even in an environment where there is background sound, with a single microphone being used, can be provided. Further, a speech communication apparatus allowing background sound to be measured more correctly, capable of clarifying received speech better based on measured background sound, and capable of clarifying received speech reaching the person who transmits speech, without largely reducing the sound quality of the received speech can be provided.

### BRIEF DESCRIPTION OF THE DRAWINGS

FIG. 1 is a block diagram showing the structure of a mobile telephone according to embodiments of a present invention.

FIG. 2 is a block diagram showing the structure of a speech input-and-output processing section according to a first embodiment of a present invention.

FIG. 3A to FIG. 3E show the frequency characteristics of a transmission-speech extraction filter according to the first embodiment of a present invention.

FIG. 4A shows an equal loudness contour, FIG. 4B shows loudness curves obtained in a silent environment and a noisy environment, and FIG. 4C shows a gain used to obtain the same loudness in the silent environment and the noisy environment.

FIG. 5 is a view showing the structure of a loudness-compensation control section and a gain adjustment section according to a first embodiment of the present invention.

FIG. 6 is a block diagram showing another example structure of the speech input-and-output processing section according to a first embodiment of the present invention.

FIG. 7 is a block diagram showing still another example structure of the speech input-and-output processing section according to a first embodiment of the present invention.

FIG. 8 is a block diagram showing the structure of a speech input-and-output processing section according to a second embodiment of the present invention.

FIG. 9A and FIG. 9B show the arrangement of a background-sound microphone and a mounting form according to a second embodiment of the present invention, respectively.

FIG. 10 is a block diagram showing another example structure of the speech input-and-output processing section according to a second embodiment of the present invention.

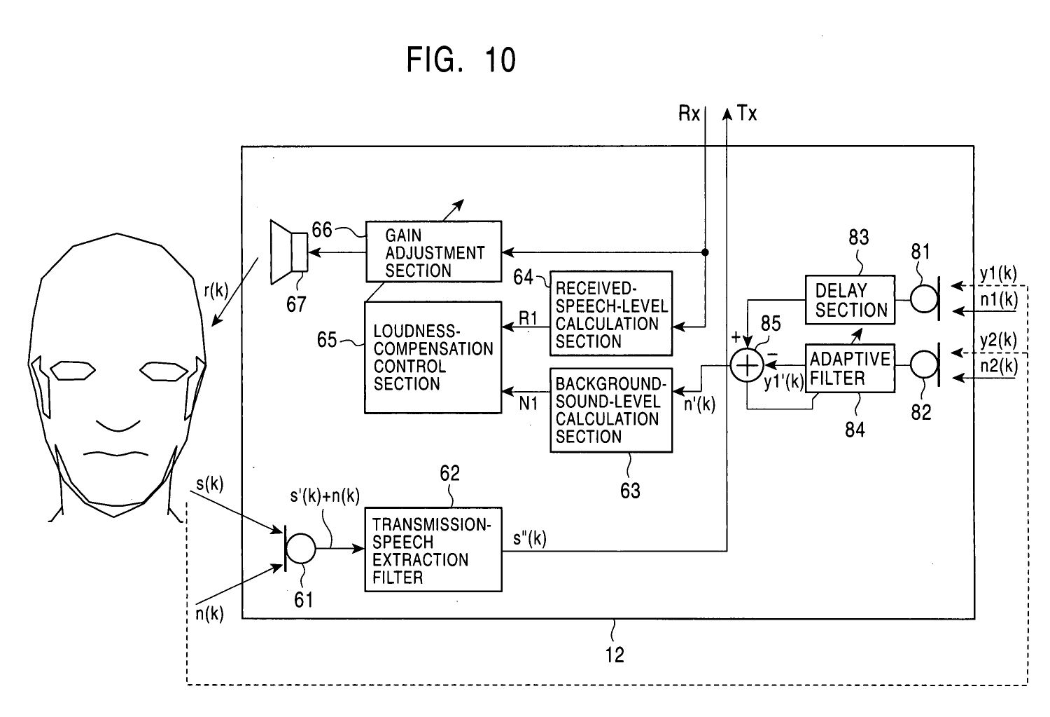

FIG. 11 is a block diagram showing the structure of a speech input-and-output processing section according to a third embodiment of the present invention.

FIG. 12 is a block diagram showing another example structure of the speech input-and-output processing section according to a third embodiment of the present invention.

### DESCRIPTION OF THE PREFERRED EMBODIMENTS

Embodiments of the present invention will be described below with a case in which the present invention is applied to a portable, mobile telephone being taken as an example.

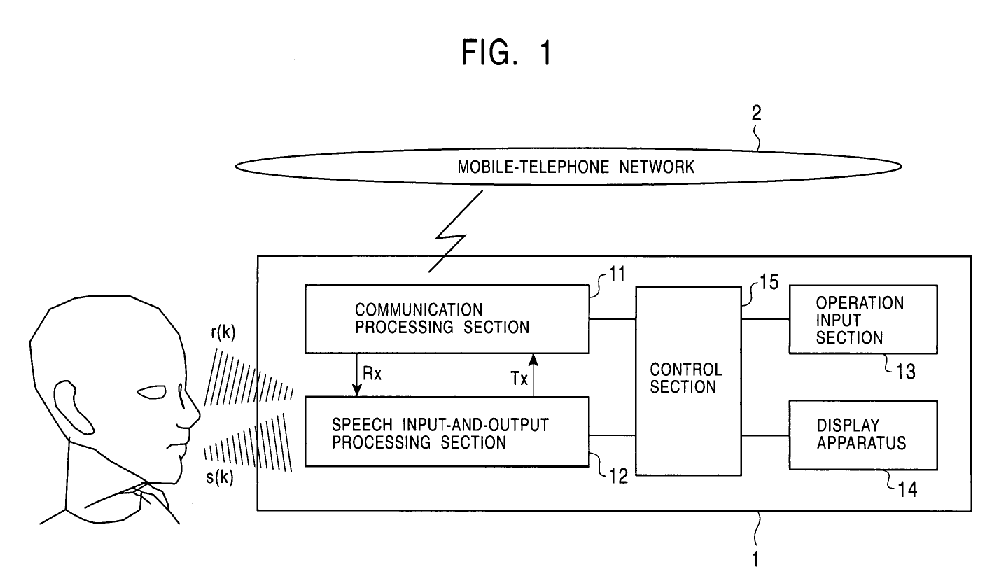

FIG. 1 shows the structure of a mobile telephone according to a first embodiment.

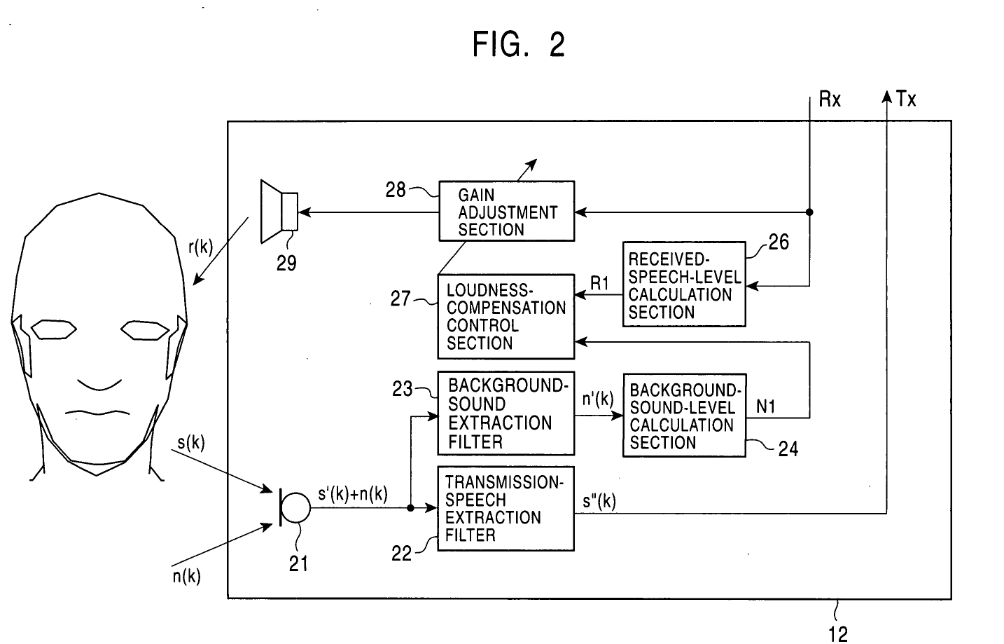

As shown in FIG. 2, the mobile telephone 1 has a communication processing section 11 for performing call control between the section 11 and a mobile telephone network 2 and for processing speech-signal transfer, and a speech input-and-output processing section 12 for processing a received-speech signal Rx received by the communication processing section 11 to output to the user as received speech r(k), and for collecting the speech s(k) to be transmitted (transmission speech s(k)) of the user and applying predetermined processing thereto to output to the communication processing section 11 as a transmission-speech signal Tx. The mobile telephone 1 also includes an operation input section 13 for receiving operations from the user, such as a telephone-number input, a display apparatus 14, and a control section 15 for controlling the operation of the communication processing section 11, the operation of the speech input-and-output processing section 12, and the display of the display apparatus 14 in response to user operations input through the operation input section 13 and a received call at the communication processing section 11.

FIG. 2 shows the structure of the speech input-and-output processing section 12.

As shown in FIG. 2, the speech input-and-output section 12 includes a transmission-speech microphone 21, a transmission-speech extraction filter 22, a background-sound extraction filter 23, a background sound level calculation section 24, a received-speech-level calculation section 26, a loudness-compensation control section 27, a gain adjustment section 28, and a speaker 29.

The transmission-speech microphone 21 is a unidirectional or bi-directional microphone, and is disposed close to the mouth of the user by the user and used in speech communications. The output signal of the transmission-speech microphone 21 is the mixture of s′(k) obtained by applying a proximity effect to the user's transmission speech s(k) and the background sound n(k).

The transmission-speech extraction filter 22 is a band-pass filter, and extracts a transmission-speech signal s″(k) from the output signal, s′(k)+n(k), of the transmission-speech microphone 21 by using the proximity effect generated by the unidirectional or bi-directional microphone.

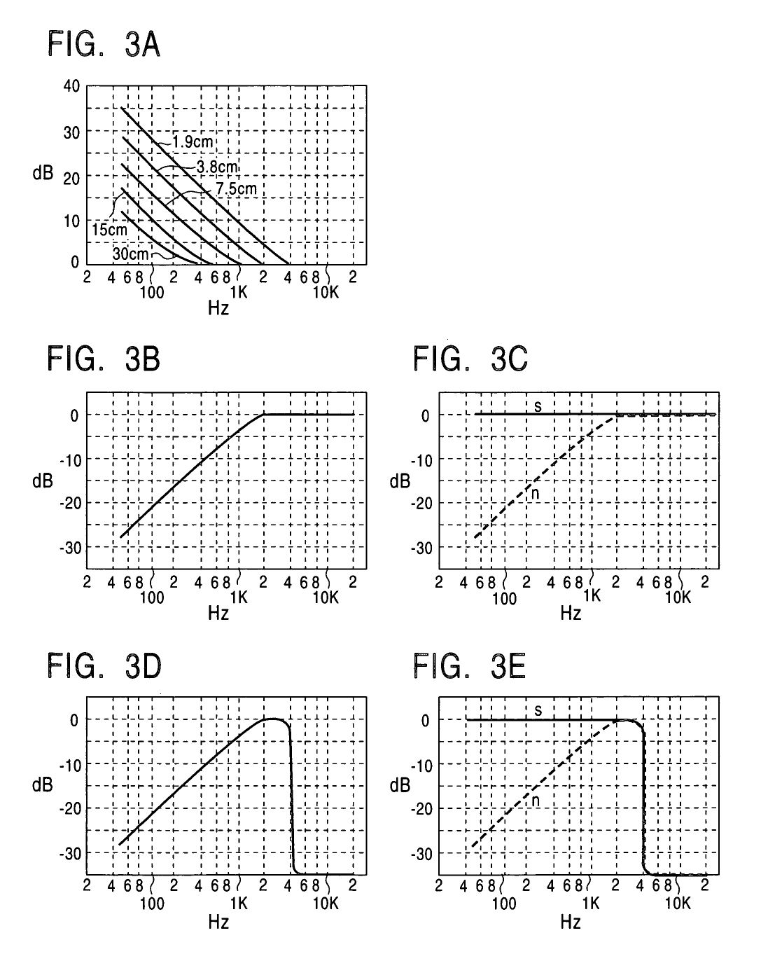

The proximity effect will be described by referring to FIG. 3A.

The proximity effect is a phenomenon in which the closer a sound source is disposed, the larger the output of low-pitched sound from a unidirectional or bi-directional microphone becomes. This phenomenon occurs because the sound of a sound source disposed close to a microphone is collected by the microphone as spherical waves whereas the sound of a sound source disposed far from the microphone is substantially collected by the microphone as plane waves. As shown in FIG. 3A for bi-directional microphones, the closer a sound source is disposed, the larger the level of low-pitched sound from the bi-directional microphone becomes. The proximity effect for unidirectional microphones are about as half as that for bi-directional microphones.

In the present embodiment, to overcome this phenomenon, a filter having the gain characteristic, as shown in FIG. 3B, reverse to that caused by the proximity effect produced by the user serving as a sound source apart from the transmission-speech microphone 21 by several centimeters (FIG. 3B shows a case of 3.8 cm) is used as the transmission-speech extraction filter 22. In other words, the filter has the gain characteristic which makes the frequency characteristic of the output of the transmission-speech microphone 21 flat. With this, the output of the transmission-speech extraction filter 22 has a flat frequency characteristic for the transmission speech s(k) and has low-frequency attenuation for the background sound n(k), for which the proximity effect is not produced, as shown in FIG. 3C. In other words, in the output of the transmission-speech extraction filter 22, the n(k) component is attenuated as shown by a line “n” in the figure and the s′(k) component is compensated for the change caused by the proximity effect as shown by a line “s” in the figure in the output signal, s′(k)+n(k), of the transmission-speech microphone 21. Therefore, the output, s″(k), of the transmission-speech extraction filter 22 can be used approximately as the transmission speech s(k).

In usual speech communications, the speech frequency band has the highest frequency as low as 3 kHz to 4 kHz in many cases. Therefore, as the transmission-speech filter 22, a frequency filter having, as shown in FIG. 3D, the gain characteristic reverse to that caused by the proximity effect produced by the user serving as a sound source, up to 3 kHz to 4 kHz, and a gain characteristic which blocks off the frequency band higher than that may be used. In this case, the output of the transmission-speech extraction filter 22 has a frequency characteristic shown in FIG. 3E.

Referring to FIG. 2, the output of the transmission-speech extraction filter 22 is sent to the communication processing section 11 as a transmission-speech signal Tx, and further sent to a communication destination through the mobile-telephone network 2.

The background-sound extraction filter 23 is a band-elimination filter, and removes the speech signal s′(K) from the output signal, s′(k)+n(k), of the transmission-speech microphone 21 to output a background-sound component n′(k). As the background-sound extraction filter 23, a low-pass filter for passing signals having frequencies equal to 200 Hz or lower, which is the lower limit of the speech frequency band of standard persons, can be used approximately.

The background sound level calculation section 24 calculates the sound-pressure level of the background-sound component n′(k) output from the background-sound extraction filter 23 in each frequency band, and sends to the loudness-compensation control section 27 as a background-sound level N1. In the calculation of the sound-pressure level, for example, the background sound level calculation section 24 performs fast Fourier transform (FFT) calculations for each predetermined time block, and calculates the average sound-pressure level in the time block for each predetermined frequency band. With a human-auditory-sense characteristic in which a difference in the magnitude of background sound can be recognized at an interval of about ⅓ octaves taken into account, the frequency domain is divided into frequency bands each having a range of ⅓ octaves, and the average sound-pressure level is calculated in the time block for each frequency band.

The received-speech-level calculation section calculates the sound-pressure level of a received-speech signal Rx input from the communication processing section 11, in each frequency band, and sends to the loudness-compensation control section 27 as a received-speech level R1. In the calculation of the received-speech level R1, for example, the received-speech-level calculation section 26 performs FFT calculations for each predetermined time block, and calculates the average sound-pressure level in the time block for each predetermined frequency band.

The loudness-compensation control section 27 and the gain adjustment section 28 apply loudness compensation to the received-speech signal Rx. The loudness-compensation control section 27 controls the amount of gain adjustment in each frequency band for the received-speech signal Rx, used in the gain adjustment section 28, according to the background-sound level N1 and the received-speech level R1. The gain adjustment section 28 adjusts a gain in each frequency band for the received-speech signal Rx according to the amount of gain adjustment in each frequency band, controlled by the loudness-compensation control section 27, and outputs to a speaker 29 as received speech r(k).

The loudness compensation applied to the received-speech signal Rx by the loudness-compensation control section 27 and the gain adjustment section 28 will be described below in detail.

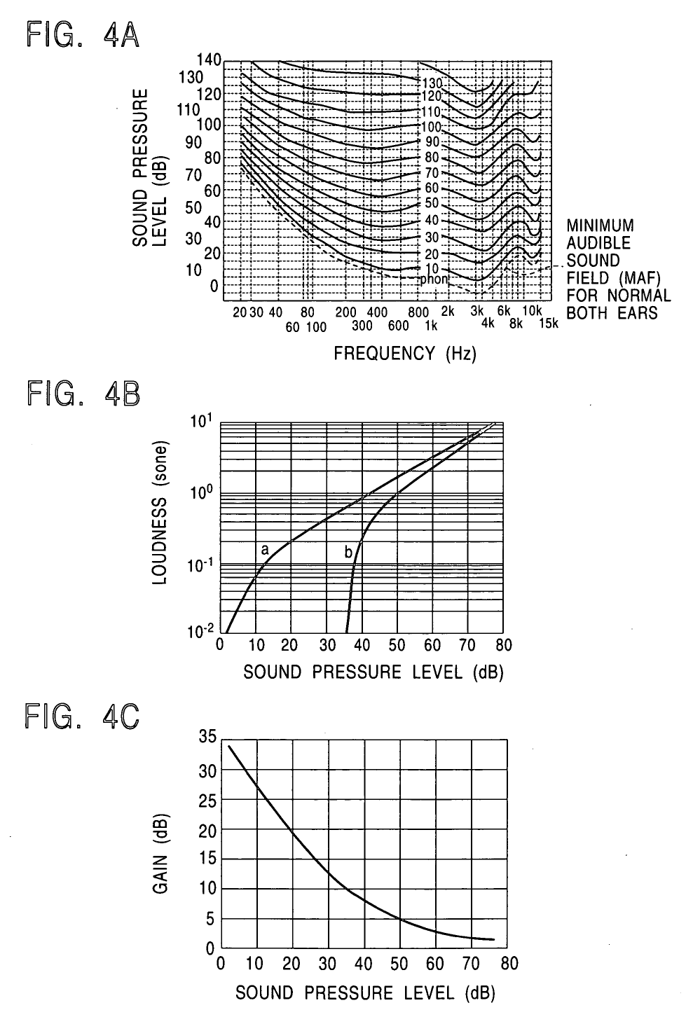

A unit for the loudness of sound perceived by persons is “sone”. The loudness of a 40 dB pure tone having a frequency of 1 kHz is set to one sone. Because the unit is based on the perception of persons, persons perceive the loudness of sound having two sone to be twice as large as that of sound having one sone. The loudness depends not only on the intensity of sound but also on its frequency. FIG. 4A shows an equal loudness contour, plotted through the sound-pressure levels of pure tones having the same loudness as a pure tone having a certain sound-pressure level and a frequency of 1 kHz in a state where there is no external noise. In other words, the equal loudness contour indicates the levels of signals having frequencies other than 1 kHz, which persons perceive to have the same loudness as a sine wave having a frequency of 1 kHz. The equal loudness contour shows that, when the loudness becomes smaller, persons perceive the level of sound in a low-frequency zone or a high-frequency zone to be smaller than the level of sound in an intermediate-frequency zone, or cannot hear the sound in the low-frequency zone or the high-frequency zone unless the level thereof is increased.

FIG. 4B shows loudness curves, each of which shows the relationship between physical sound-pressure levels and the loudness perceived by a person when the person hears the sound. In the loudness curve, the horizontal axis indicates physical sound-pressure levels (unit: dB), and the vertical axis indicates loudness (unit: sone) numerically expressing the loudness of sound, which a person perceives. In FIG. 4B, a loudness curve (a) is for a silent environment, and a loudness curve (b) is for an environment with noise. The loudness curve (b) shows an environment in which the human minimum audible level is increased by about 35 dB by background sound, and is variously changed due to a change in the background sound.

In these loudness curves, when loudness values along the vertical axis are equal, it indicates that persons perceive the corresponding sound to have the same loudness. Sound which persons perceive to have a loudness of 0.1 sone needs to have a physical sound-pressure level of 12 dB in the silent environment (a) but needs to have a physical sound-pressure level of 37 dB in the noisy environment (b). In other words, persons perceive sound to have the same loudness when the speaker 29 outputs at a physical sound-pressure level of 12 dB in the silent environment whereas the speaker 29 outputs at a physical sound-pressure level of 37 dB in the noisy environment. To hear sound which persons perceive to have a loudness of 0.1 sone, in the noisy environment, a gain of 25 dB needs to be applied compared with the case in the silent environment. Sound which persons perceive to have a loudness of 1 sone needs to have a physical sound-pressure level of 42 dB in the silent environment (a) but needs to have a physical sound-pressure level of 49 dB in the noisy environment (b), which indicates that a gain of 7 dB needs to be applied in the noisy environment.

To make persons perceive a constant loudness irrespective of the level of background sound, it is necessary to change a gain in the above-described way according to not only the level of background sound but also the sound-pressure level of sound output from the speaker 29. FIG. 4C shows a gain required to be applied at each sound-pressure level in a silent environment in order to make persons perceive sound to have the same loudness in a noisy environment and the silent environment. In the figure, the horizontal axis indicates the sound-pressure level of sound output in the silent environment, and the vertical axis indicates the gain which needs to be applied in the noisy environment in order to make persons perceive sound to have the same loudness as in the silent environment. For example, when a gain of about 19 dB is applied to sound having a sound-pressure level of 20 dB output in the silent environment, persons in the noisy environment perceive the sound to have the same loudness as in the silent environment.

To make sound have the same easiness in hearing for the user, a different gain needs to be applied to a received-speech signal output from the speaker 29 according to the level of background sound and the sound-pressure level of the sound output from the speaker. Because the background sound has a different sound-pressure level at each frequency band, and easiness in hearing sound for the user differs at each frequency band as indicated by the equal loudness contour of FIG. 4A, the gain that needs to be applied to the speaker-output sound in order to provide the same easiness in hearing in each frequency band is required to be different in each frequency band.

In a preferred embodiment, the amount of gain adjustment that implements easiness in hearing irrespective of the background-sound level N1 and the frequency band is specified for a combination of a received-speech level R1 and a background-sound level N1 at each frequency band; the loudness-compensation control section 27 selects, at each frequency band, the amount of gain adjustment specified in advance for a combination of the background-sound level N1 calculated in the background sound level calculation section 24 and the received-speech level R1 calculated in the received-speech-level calculation section 26; and the gain adjustment section 28 adjust the gain of the received-speech signal Rx in each frequency band according to the amount of gain adjustment selected at each frequency band.

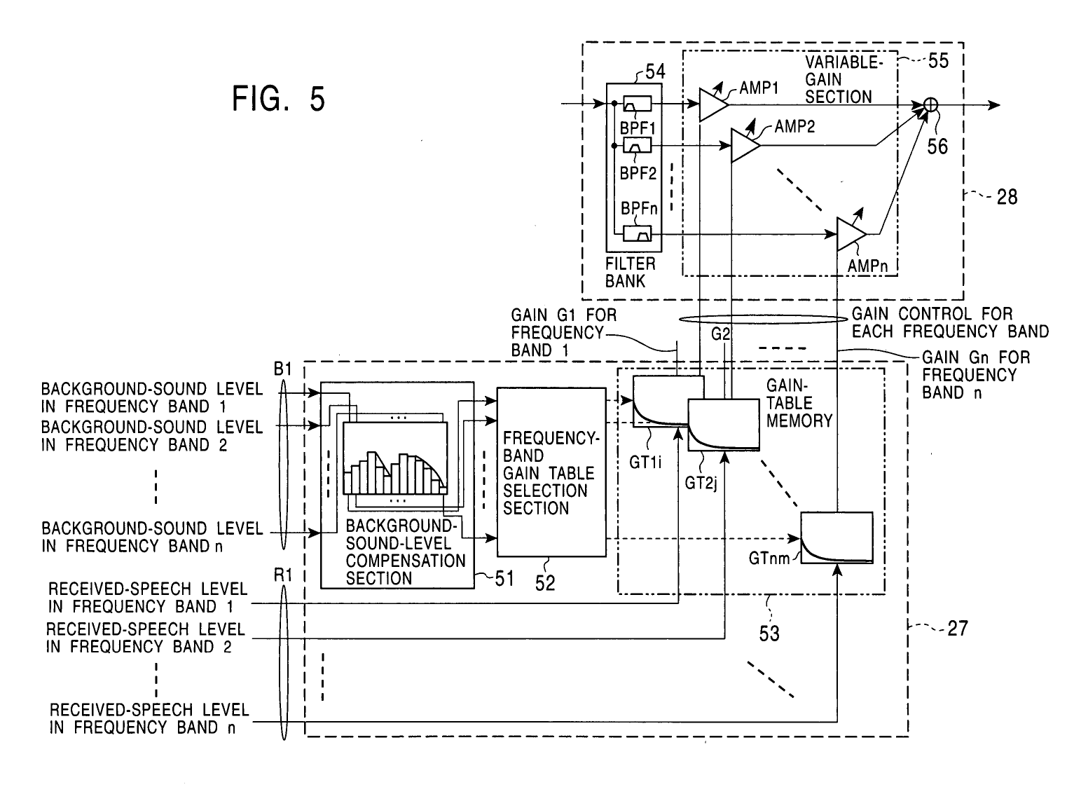

FIG. 5 shows an example structure of the loudness-compensation control section 27. As shown in FIG. 5, the loudness-compensation control section 27 includes a background sound level compensation section 51, a frequency-band gain table selection section 52, and a gain table memory 53.

The gain table memory 53 records in advance gain tables each of which specifies the relationship between the received-speech level R1 and the gain to be applied, for a combination of a background-sound level N1 and a frequency band, such as relationships shown in the figure.

The background-level compensation section 51 uses the Zwicker's loudness calculation method (ISO 532B) or the Stevens' loudness calculation method (ISO 532A) to adjust the background-sound level N1 in each frequency band, output from the background-level calculation section 24. Background sound having a certain frequency affects not only easiness in hearing received speech having the same frequency but also easiness in hearing received speech having frequencies slightly higher than the frequency. With this being taken into account, the background sound level compensation section 51 adjusts the sound-pressure level of background sound having each frequency according to the magnitude of the sound-pressure level of background sound having lower frequencies than the frequency. When the sound-pressure level of background sound having lower frequencies than the frequency is high, the sound-pressure level of background sound having the frequency is compensated slightly larger. With such adjustment being performed, only the sound-pressure level of background sound in each frequency band needs to be taken into account when the gain table in the frequency band is selected. It is not necessary to perform troublesome processing in which noise in a frequency band adjacent at a lower frequency side is taken into account.

Then, the frequency-band gain table selection section 52 selects the gain table corresponding to each frequency band and the adjusted sound-pressure level of background sound in the frequency band, output from the background sound level compensation section 51. The selected gain table is used for the frequency band to calculate the gain corresponding to the sound-pressure level in the frequency band, indicated by the received-speech level R1 input from the received-speech-level calculation section 26, and the gain is sent to the gain adjustment section 28.

The gain adjustment section 28 includes a filter bank 54, a variable-gain section 55, and an adder 56. The filter bank 54 is a group of band-pass filters having predetermined frequency bandwidths. The group of band-pass filters is used to divide the received-speech signal Rx according to the frequency bands. The variable-gain section 55 applies the gain in each frequency band, calculated by the loudness-compensation control section 27, to the received-speech signal Rx divided according to the frequency bands, output from the filter bank 54, to perform gain adjustment. The adder 56 adds received-speech-signal components to which the gain adjustment has been applied in the respective frequency bands to output received speech r(k).

According to the first embodiment, the frequency characteristic of the output of the transmission-speech microphone 21 is manipulated in order to cancel the proximity effect produced at the output of the transmission-speech microphone 21 to flatten the frequency characteristic of transmission speech included in the output of the transmission-speech microphone 21, and the level of background sound included in the output of the transmission-speech microphone 21 is reduced to successfully extract the transmission speech. Therefore, the quality of the transmission speech is improved.

In addition, background sound is extracted from the output of the transmission-speech microphone 21 with the use of the background-sound extraction filter 23, the level of the background sound is calculated, and received speech is clarified according to the level. Therefore, there is no need to separately provide, in addition to the transmission-speech microphone, a microphone for collecting background sound.

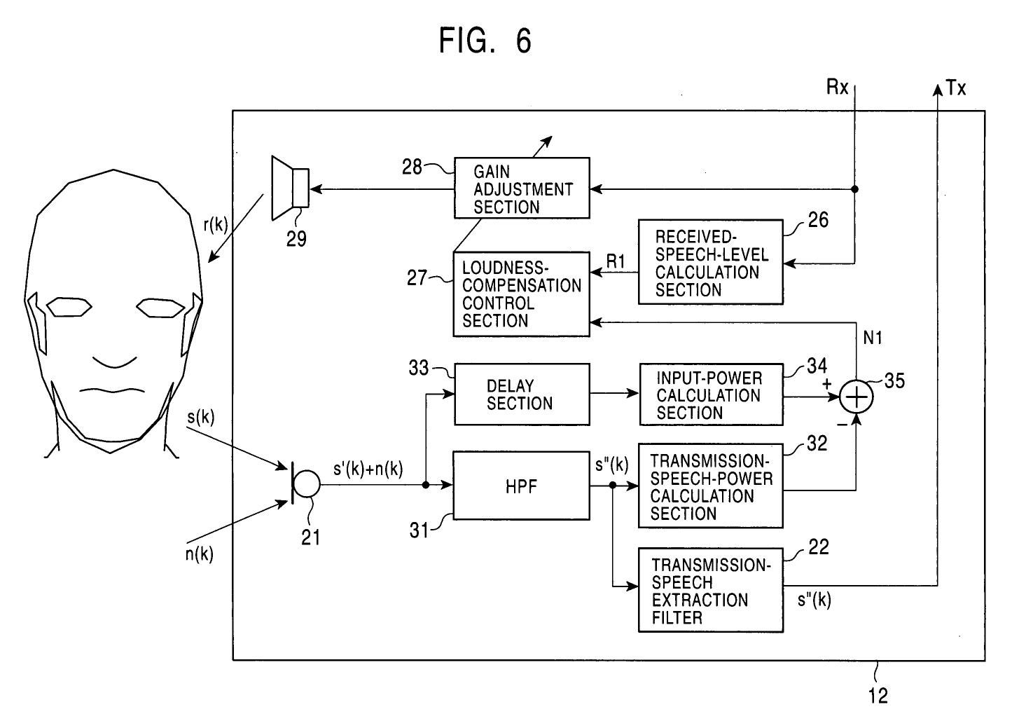

The background sound level N1 can be calculated by a structure shown in FIG. 6 in the speech input-and-output processing section 12 according to the first embodiment.

Instead of the background-sound extraction filter 23 and the background sound level calculation section 24, the speech input-and-output processing section 12 additionally includes a high-pass filter 31 for extracting the transmission-speech signal s′(k) from the output signal, s′(k)+n(k), of the transmission-speech microphone 21, a transmission-speech-power calculation section 32 for calculating, in each frequency band, the sound-pressure level of the transmission-speech signal s′(k) output from the high-pass filter 31, a delay section 33 for applying the period of delay caused by the processing of the high-pass filter 31 to the output signal, s′(k)+n(k), of the transmission-speech microphone 21, an input-power calculation section 34 for calculating, in each frequency band, the sound-pressure level of the delayed output signal, s′(k)+n(k), of the transmission-speech microphone 21, and an adder 35. The sound-pressure level calculated by the transmission-speech-power calculation section 32 is subtracted from the sound-pressure level calculated by the input-power calculation section 34 in each frequency band by the adder 35, and the result is regarded as the background-sound level N1 in each frequency band. The high-pass filter 31 passes, for example, signals in frequency bands higher than 200 Hz, which is the lower limit of the standard human speech frequency band.

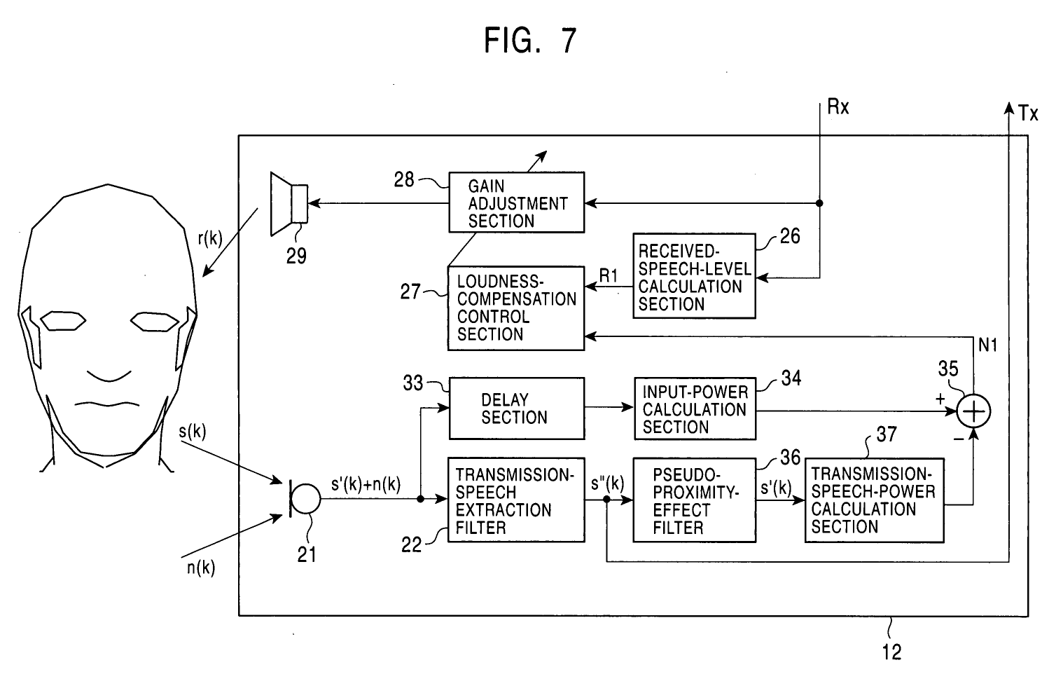

The background sound level N1 can also be calculated by a structure shown in FIG. 7 in the speech input-and-output processing section 12 according to the first embodiment.

Instead of the background-sound extraction filter 23 and the background sound level calculation section 24, the speech input-and-output processing section 12 additionally includes a pseudo-proximity-effect filter 36 for applying a pseudo proximity effect similar to the proximity effect shown in FIG. 3a to the output s″(k) of the transmission-speech extraction filter 22, a transmission-speech-power calculation section 37 for calculating, in each frequency band, the sound-pressure level of the output s′(k) of the pseudo-proximity-effect filter 36, a delay section 33 for applying the period of delay caused by the processing of the transmission-speech extraction filter 22 and the pseudo-proximity-effect filter 36 to the output signal, s′(k)+n(k), of the transmission-speech microphone 21, an input-power calculation section 34 for calculating, in each frequency band, the sound-pressure level of the delayed output signal, s′(k)+n(k), of the transmission-speech microphone 21, and an adder 35. The sound-pressure level calculated by the transmission-speech-power calculation section 37 is subtracted from the sound-pressure level calculated by the input-power calculation section 34 in each frequency band by the adder 35, and the result is regarded as the background-sound level N1 in each frequency band. With such a structure, it is expected that the background-sound level N1 can be calculated more properly because the background sound is attenuated by the attenuation effect of the transmission-speech extraction filter 22 to a no sound level for the pseudo-proximity-effect filter 36, and hence, the background sound cannot be amplified by the pseudo-proximity-effect filter 36.

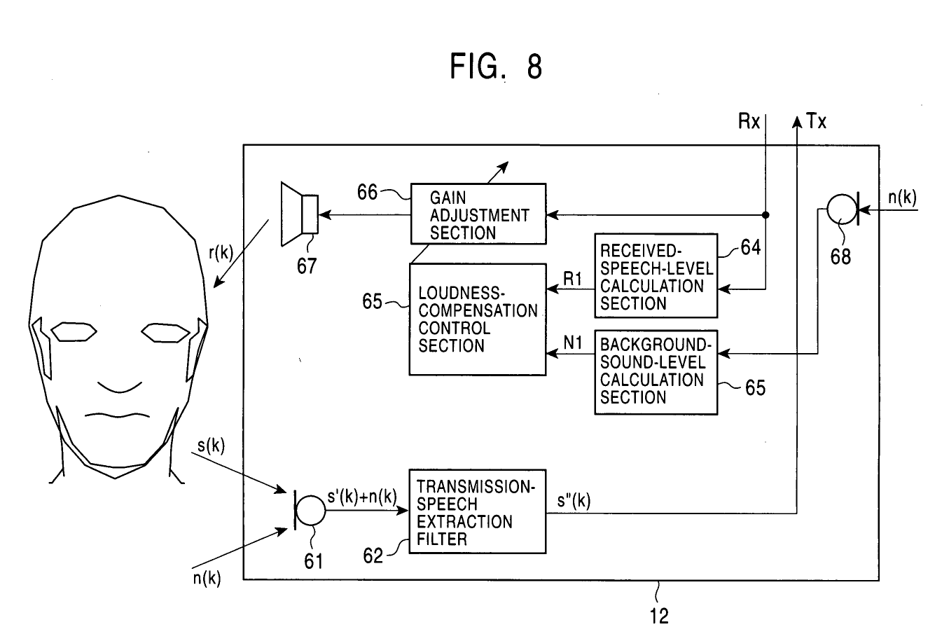

A mobile telephone according to the second embodiment has the same structure as the mobile telephone 1, shown in FIG. 1, according to the first embodiment except that the speech input-and-output processing section 12 is structured as shown in FIG. 8.

As shown in FIG. 8, the speech input-and-output processing section 12 according to the second embodiment includes a transmission-speech microphone 61, a transmission-speech extraction filter 62, a background sound level calculation section 63, a received-speech-level calculation section 64, a loudness-compensation control section 65, a gain adjustment section 66, a speaker 67, and a background-sound microphone 68.

The transmission-speech microphone 61 is a unidirectional or bi-directional microphone, and is disposed close to the mouse of the user by the user and used in speech communications. The output signal of the transmission-speech microphone 61 is the mixture of s′(k) obtained by applying a proximity effect to the user's transmission speech s(k) and the background sound n(k).

As in the first embodiment, the transmission-speech extraction filter 62 is a band-pass filter, and extracts a transmission-speech signal s″(k) from the output signal, s′(k)+n(k), of the transmission-speech microphone 61 by using the proximity effect generated by the unidirectional or bi-directional microphone, and sends to the communication processing section 11 as a transmission-speech signal Tx. The transmission-speech signal Tx is sent to the communication destination through the mobile-telephone network 2.

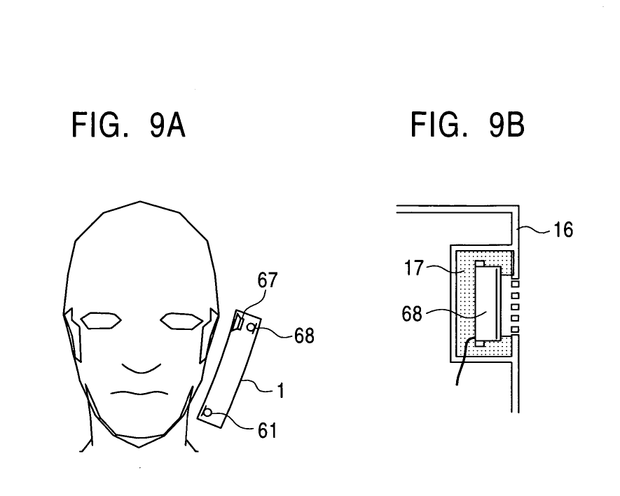

The background-sound microphone 68 is a unidirectional microphone, and is disposed as shown in FIG. 9A at a position having almost the same height as the speaker 67, at the rear side of the mobile telephone so as to collect, near an ear of the user, only background sound in the rear-surface direction of the mobile telephone without collecting the transmission speech s(k) of the user. In addition, the background-sound microphone 68 is mounted to the mobile telephone as shown in FIG. 9B by using a sound absorbing member 17 so as not to directly contact the body 16 of the mobile telephone in order that received speech output from the speaker 67 is not collected by the background-sound microphone 68 through the body 16 of the mobile telephone.

Back to FIG. 8, the background sound level calculation section 63 calculates the sound-pressure level of the output signal n(k) of the background-sound microphone 68 in each frequency band, and sends to the loudness-compensation control section 27 as the background-sound level N1. The received-speech-level calculation section 64 calculates the sound-pressure level of the received-speech signal Rx input from the communication processing section 11 in each frequency band, and sends to the loudness-compensation control section 65 as the received-speech level R1. In the same way as in the first embodiment, the sound-pressure levels are calculated in the background sound level calculation section 63 and the received-speech-level calculation section 64 by performing FFT calculations in each predetermined time block, and by calculating the average sound-pressure level in the time block for each frequency band having, for example, ⅓ octaves.

The loudness-compensation control section 65 and the gain adjustment section 66 controls the amount of gain adjustment for the received-speech signal Rx in each frequency band in the gain adjustment section 66 according to the background-sound level N1 calculated in each frequency band by the background sound level calculation section 63 and the received-speech level R1 calculated by the received-speech-level calculation section 64, as in the first embodiment.

According to the second embodiment, the background-sound microphone 68 is disposed at a position having almost the same height as the speaker 67, at the rear side of the mobile telephone to collect sound close to the background sound the user hears by an ear and to remove the mixture of the transmission speech into the output of the background-sound microphone 68. The background-sound level can be more properly calculated to effectively clarify the received speech according to the background-sound level.

The unidirectional background-sound microphone according to the second embodiment can be replaced with a combination of two non-directional microphones, a first microphone 81 and a second microphone 82, a delay section 83, an adaptive filter 84, and an adder 85.

The adder 85 subtracts the output signal of the adaptive filter 84 from the speech signal generated from sound collected by the first microphone 81 and delayed by the delay section 83 by a delay period appropriately determined according to the difference in the arrival timing of the user's transmission speech to the first microphone 81 and to the second microphone 82, and outputs the result to the background sound level calculation section 63. The adaptive filter 84 updates its filter characteristic (impulse response) by an LMS algorithm or an NLMS algorithm such that the output of the adder 85 becomes minimum, to estimate a transmission-speech signal y1′(k) included in a speech signal which includes the background sound n1(k) and the transmission-speech y1(k) generated from sound collected by the first microphone 81, from a speech signal which includes the background sound n2(k) and the transmission-speech y2(k) generated from sound collected by the second microphone 82. As a result, the output of the adder 85 is a signal generated by an element obtained by subtracting the transmission speech y′1(k) from the speech signal generated by sound collected by the second microphone 82, that is, a signal having only the background sound n1 (k).

When the delay period of the delay section 83 is appropriately specified in this state, directivity in which only sound produced in the mouth direction of the user is masked is given to the output of the non-directional first microphone 81. Because the user's auditory sense is close to non-directional, the level of background sound the user hears can be more correctly calculated to clarify the received speech effectively according to the level.

When the optimum filter characteristic can be obtained in advance, the adaptive filter 84 may be replaced with a fixed filter.

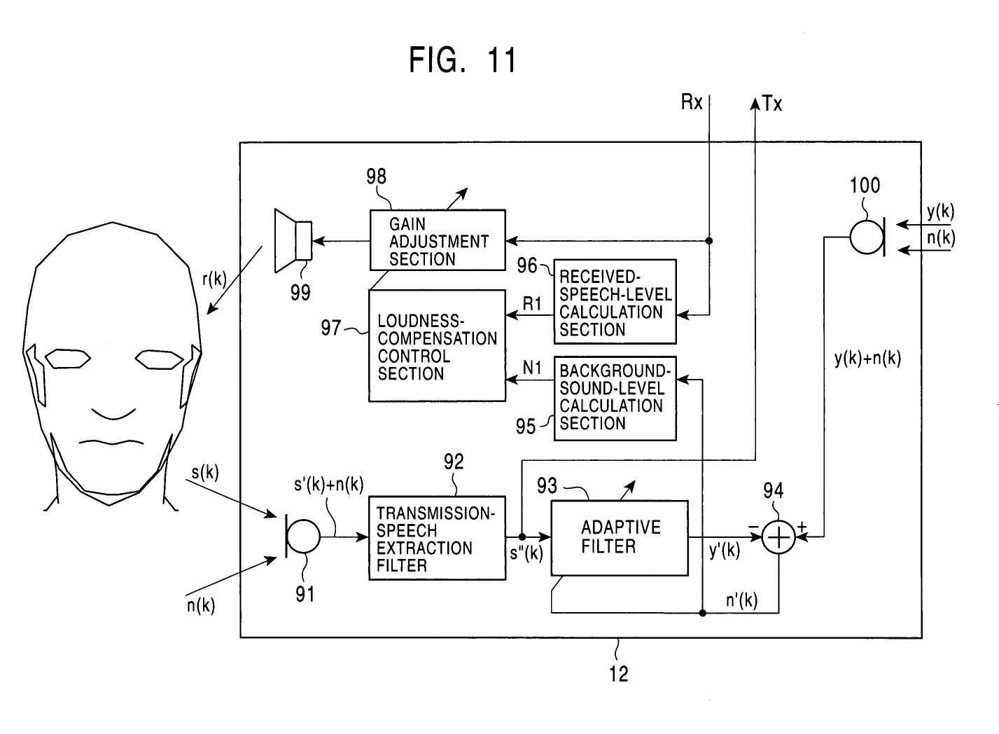

A mobile telephone according to the third embodiment has the same structure as the mobile telephone 1, shown in FIG. 1, according to the first embodiment except that the speech input-and-output processing section 12 is structured as shown in FIG. 11.

As shown in FIG. 11, the speech input-and-output processing section 12 according to the third embodiment includes a transmission-speech microphone 91, a transmission-speech extraction filter 92, an adaptive filter 93, an adder 94, a background sound level calculation section 95, a received-speech-level calculation section 96, a loudness-compensation control section 97, a gain adjustment section 98, a speaker 99, and a background-sound microphone 100.

The transmission-speech microphone 91 is a unidirectional or bi-directional microphone, and is disposed close to the mouth of the user by the user and used in speech communications. The output signal of the transmission-speech microphone 91 is the mixture of s′(k) obtained by applying the proximity effect to the user's transmission speech s(k) and the background sound n(k).

As in the first embodiment, the transmission-speech extraction filter 92 is a band-pass filter, and extracts a transmission-speech signal s″(k) from the output signal, s′(k)+n(k), of the transmission-speech microphone 91 by using the proximity effect generated by the unidirectional or bi-directional microphone, and sends to the communication processing section 11 as a transmission-speech signal Tx. The transmission-speech signal Tx is sent to the communication destination through the mobile-telephone network 2.

The background-sound microphone 100 is a unidirectional microphone, and is disposed as shown in FIG. 9A at a position having almost the same height as the speaker 99, at the rear side of the mobile telephone so as to collect, near an ear of the user, only background sound in the rear-surface direction of the mobile telephone without collecting the transmission speech of the user, in the same way as the background-sound microphone 68 used in the second embodiment. In addition, the background-sound microphone 100 is mounted to the mobile telephone as shown in FIG. 9B by using a sound absorbing member 17 so as not to directly contact the body 16 of the mobile telephone in order that received speech output from the speaker 99 is not collected by the background-sound microphone 100 through the body 16 of the mobile telephone. The output of the background-sound microphone 100 is the mixture of background sound n(k) and transmission speech y(k).

The adder 94 subtracts the output signal of the adaptive filter 93 from the speech signal generated from sound collected by the background-sound microphone 100 and outputs the result to the background sound level calculation section 95. The adaptive filter 93 updates its filter characteristic (impulse response) by an LMS algorithm or an NLMS algorithm such that the output of the adder 94 becomes minimum, to estimate from transmission speech s″(k) extracted by the transmission-speech filter 92, a transmission-speech signal y′(k) mixed into the speech signal generated from sound collected by the background-sound microphone 100. Therefore, the signal n′(k) output from the adder 94 to the background sound level calculation section 95 is a signal obtained by subtracting transmission speech y′(k) from the speech signal generated by sound collected by the background-sound microphone 100, that is, a signal having only background sound n(k).

The background sound level calculation section 95 calculates the sound-pressure level of the output signal n(k) of the background-sound microphone 100 in each frequency band, and sends to the loudness-compensation control section 97 as the background-sound level N1. The received-speech-level calculation section 96 calculates the sound-pressure level of the received-speech signal Rx input from the communication processing section 11 in each frequency band, and sends to the loudness-compensation control section 97 as the received-speech level R1. In the same way as in the first embodiment, the sound-pressure levels are calculated in the background sound level calculation section 95 and the received-speech-level calculation section 96 by performing FFT calculations in each predetermined time block, and by calculating the average sound-pressure level in the time block for each frequency band having, for example, ⅓ octaves.

The loudness-compensation control section 97 and the gain adjustment section 98 controls the amount of gain adjustment for the received-speech signal Rx in each frequency band in the gain adjustment section 98 according to the background-sound level N1 calculated by the background sound level calculation section 95 and the received-speech level R1 calculated by the received-speech-level calculation section 96, as in the first embodiment.

According to the third embodiment, the background-sound microphone 100 is disposed at a position having almost the same height as the speaker 99, at the rear side of the mobile telephone, as a non-directional microphone, to collect sound close to the background sound the user hears by an ear, and transmission speech including in the output of the background-sound microphone 100 is correctly estimated according to the transmission speech correctly extracted from the output of the transmission-speech microphone 91 with the user of the proximity effect as described before. Then, the estimated transmission speech is removed from the output of the background-sound microphone 100. Therefore, the level of background sound which the user hears more properly can be calculated, and the received speech can be effectively clarified according to the background-sound level.

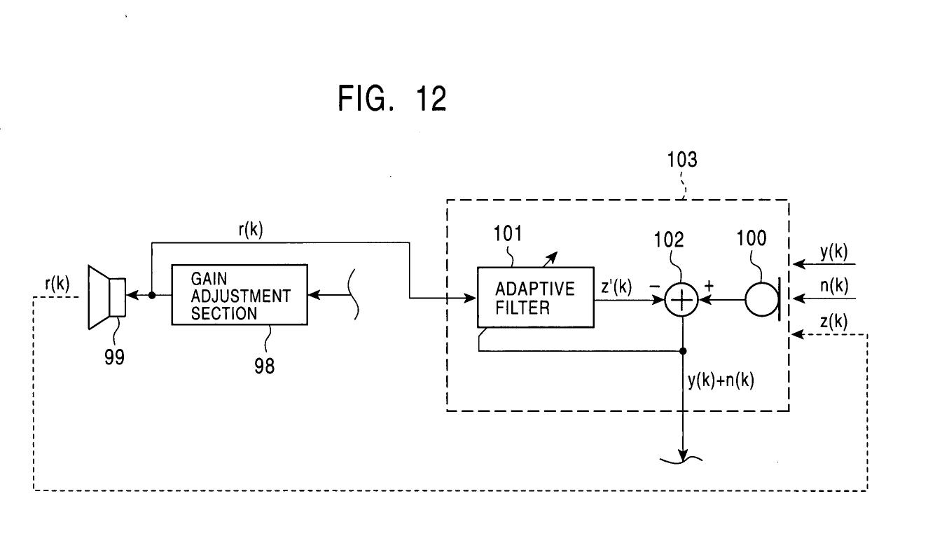

In the third embodiment, described above, to further suppress the mixture of the received speech r(k) output from the speaker 99 into the speech signal generated from sound collected by the background-sound microphone 100, an echo canceller 103 formed of an adaptive filter 101 and an adder 102 may be provided as shown in FIG. 12. The adder 102 subtracts the output signal of the adaptive filter 101 from the speech signal generated from sound collected by the background-sound microphone 100, and outputs the result instead of the output of the background-sound microphone shown in FIG. 11. The adaptive filter 101 updates its filter characteristic (impulse response) by the LMS algorithm or the NLMS algorithm such that the output of the adder 102 becomes minimum, to estimate from the received-speech signal r(k) output from the gain adjustment section 98, received speech z′(k) going through to the background-sound microphone 100. As a result, in the output of the adder 102, received speech output from the speaker 99 and going through to the background-sound microphone 100 is removed from the speech signal generated from sound collected by the background-sound microphone 100.

The technology for canceling the output from the speaker 99 shown in FIG. 11 and going through to the background-sound microphone 100 can be applied in the same way to the background-sound microphone used in the second embodiment.

In the above-described embodiments, the speech frequency band is divided into a plurality of frequency bands, and the loudness compensation where a gain for received speech is adjusted in each frequency band is performed. This may be simplified in a manner in which loudness compensation is performed in which gain adjustment is achieved for the entire speech frequency band with one amount of gain adjustment.

In the above embodiments, the cases in which the present invention is applied to mobile telephones, such as portable telephones, PHSs, and car telephones, are taken as examples. The technology for clarifying received speech according to the above-described embodiments can be applied in the same way to any telephones, such as desk telephones and handset-type extensions connected by radio to a desk telephone if the user holds a handset provided with a transmission-speech microphone and a speaker, and performs speech input and output with the telephones. The present invention can also be applied to speech communication apparatuses which do not use a handset. A certain advantage is expected also in this case.

It is to be understood that a wide range of changes and modifications to the embodiments described above will be apparent to those skilled in the art and are contemplated. It is therefore intended that the foregoing detailed description be regarded as illustrative, rather than limiting, and that it be understood that it is the following claims, including all equivalents, that are intended to define the spirit and scope of the invention.

What is claimed is:

1. A speech communication apparatus for bi-directional speech communications, comprising:
a speaker;
a microphone;
background sound level measurement means for extracting background sound from the output of the microphone and for measuring the level of the extracted background sound; and
received-speech clarifying means for adjusting a gain for the received speech to be output to the speaker according to the level of the background sound measured by the background sound level measurement means.

2. The speech communication apparatus of claim 1, further comprising:
received-speech-level measurement means for measuring the level of a received-speech signal received in the speech communications at each predetermined frequency band,
wherein the background sound level measurement means measures the level of the background sound in each predetermined frequency band and the received-speech clarifying means performs loudness compensation in which the gain for the received-speech signal is adjusted in each predetermined frequency band such that the received speech is heard at almost the same intensity in the human auditory sense irrespective of the level of the background sound, and the resultant signal is output to the speaker as the received speech.

3. The speech communication apparatus of claim 1, wherein the speech communication apparatus is a portable, mobile telephone for performing the speech communications by radio communication.

4. A speech communication apparatus for bi-directional speech communications, comprising:
a speaker;
a microphone;
background sound level measurement means for manipulating the frequency characteristic of the output of the microphone to minimize the proximity effect produced in the output of the microphone to extract speech to be transmitted from the output of the microphone, and for measuring the level of background sound according to the extracted speech to be transmitted; and
received-speech clarifying means for adjusting a gain for the received speech to be output to the speaker according to the level of the background sound measured by the background sound level measurement means.

5. The speech communication apparatus of claim 4, wherein the microphone is a unidirectional or bi-directional microphone.

6. A speech communication apparatus according to claim 4, further comprising
received-speech-level measurement means for measuring the level of a received-speech signal received in the speech communications,
wherein the background sound level measurement means measures the level of the background sound in each predetermined frequency band and the received-speech clarifying means performs loudness compensation in which the gain for the received-speech signal is adjusted in each predetermined frequency band

7. The speech communication apparatus according to claim 4, wherein the speech communication apparatus is a portable, mobile telephone for performing the speech communications by radio communication.

8. A speech communication apparatus comprising:
a speaker;
a microphone;
a background sound microphone;
a transmission speech filter operable to reduce the level of a lower frequency component outputted by the microphone;
an adaptive filter operable to estimate speech signals outputted by the background sound microphone;
an adder operable to subtract the estimated speech signal from the output of the background sound microphone;
a background sound level calculator operable to calculate the level of the signal outputted from the adder and the level of the background sound;
a background sound level filter operable to minimize proximity effect; and
a received speech clarifying filter operable to adjust the gain for received speech according to the background sound level.

9. A speech communication apparatus according to claim 8, further comprising transmission means for transmitting the output of the transmission-speech filter as a transmission-speech signal by the speech communications.

10. A speech communication apparatus for bi-directional speech communications, provided with a handset having at a front face a speaker for outputting received speech and a transmission-speech microphone for collecting speech to be transmitted, the speech communication apparatus comprising:
a background-sound microphone disposed at the rear face of the handset at almost the same height as the speaker, for collecting background sound;
background sound level measurement means for measuring the level of the output of the background-sound microphone as a background-sound level; and
received-speech clarifying means for adjusting a gain for received speech output to the speaker according to the background-sound level measured by the background sound level measurement means.

11. A speech communication apparatus of claim 10, wherein the background-sound microphone is a unidirectional microphone.

12. A speech communication apparatus of claim 10, further comprising
received-speech-level measurement means for measuring, at each predetermined frequency band, the level of a received-speech signal received in the speech communications,
wherein the background sound level measurement means measures the level of the background sound in each predetermined frequency band, and
the received-speech clarifying means performs loudness compensation in which the gain for the received-speech signal is adjusted in each predetermined frequency band.

13. The speech communication apparatus of claim 10 wherein the speech communication apparatus is a portable, mobile telephone for performing the speech communications by radio communication.

14. A speech communication apparatus for bi-directional speech communications, comprising:
a speaker for outputting received speech;
a microphone for collecting speech to be transmitted;
background sound level measurement operable to measure the level of background sound; and
received-speech clarifying section operable to adjust a gain for the received speech to be outputted to the speaker according to the level of the background sound measured by the background sound level measurement means,
the background sound level measurement calculator comprising:
a delay section operable to delay the output of the first background-sound microphone by the period corresponding to the delay time between transmission speech mixed into the output of the first background-sound microphone and transmission speech mixed into the output of the second background-sound microphone,
an adaptive filter operable to estimate transmission speech mixed into the output of the delay section,
an adder operable to subtract the transmission speech estimated by the adaptive filter from the output of the delay means, and
background sound level calculation section operable to calculate the level of the output of the subtracting means and for outputting the result as the level of the background sound.

15. The speech communication apparatus of to claim 14, wherein the adaptive filter estimates the transmission speech according to the difference between the output of the delay means and the transmission speech estimated by the adaptive filter.

16. A speech communication apparatus according to claim 14, further comprising;
a received-speech-level measurement section operable to measure, at each predetermined frequency band the level of a received-speech signal received in the speech communications,
wherein the background sound level measurement section measures the level of the background sound in each predetermined frequency band, and
the received-speech clarifying section performs loudness compensation in which the gain for the received-speech signal is adjusted in each predetermined frequency band.

17. The speech communication apparatus of claim 14, wherein the speech communication apparatus is a portable, mobile telephone for performing the speech communications by radio communication.

18. A speech communication method for bi-directional speech communications, comprising the acts of:
manipulating the frequency characteristic of the output of a microphone for collecting speech to be transmitted in order to diminish the proximity effect produced in the output of the microphone to extract speech to be transmitted from the output of the microphone;
measuring the level of background sound according to the extracted speech to be transmitted; and
adjusting a gain for received speech to be outputted to the speaker according to the measured level of the background sound.

19. The speech communication method of claim 18, wherein the microphone is a unidirectional or bi-directional microphone.

20. The speech communication method of claim 18, further comprising the act of measuring, at predetermined frequency band, the level of a received-speech signal received in the speech communications,
wherein the level of the background sound is measured in each predetermined frequency band, and loudness compensation is performed in which the gain for the received-speech signal is adjusted in each predetermined frequency band, and the resultant signal is outputted to the speaker as the received speech.
